(19) United States
(12) Patent Application Publication
(10) Pub. No.: US 2005/0181260 A1
(43) Pub. Date: Aug. 18, 2005

(54) Elastomeric separator plates and mehtod of fabrication

(76) Inventors: Yuqi Cai, Kingston (CA); Tuyu Xie, Kingston (CA); Divya Chopra, Brights Grove (CA); Michael Waller, Waterloo (CA); Jay A. Peters, Sarnea (CA)

Correspondence Address: Thomas W Gorman;E I du Pont de Nemours & Company, Legal Patents, Wilmington, DE, 19805, US

(21) Appl. No.: 10/518,877

(22) PCT Filed: Jun. 18, 2003
(86) PCT No.: PCT/CA03/00920

Related U.S. Application Data
(60) Provisional application No. 60/394,921, filed on Jul. 10, 2002.

(51) Int. Cl. H01M 2/08; H01M 8/02; C08J 5/00

(52) U.S. Cl. 429/35; 429/38; 264/330

(57) ABSTRACT

An electrically conductive flow field separator plate is disclosed for use in a proton exchange membrane fuel cell. The plate comprises a frame portion, a central planar portion within the frame and a flow field formed in a surface of the central planar portion. The frame portion is elastomeric so as to form a seal with adjacent fuel cell components thereby eliminating the use of separate sealing elements. The frame and the central planar portion are of unitary construction and comprise from about 10 wt. % to about 50 wt. % of elastomer and from about 50 wt. % to about 90 wt. % of conductive filler.

### FIELD OF THE INVENTION

The present invention relates to improved electrically conductive flow field separator plates for use in proton exchange membrane fuel cells and to a method of making such plates. In particular, the plates of the present invention are elastomeric so as to provide excellent sealing at the plate/membrane interface without the need for a separate sealing gasket and also provide elastomeric contact and protection at the plate/MEA (Membrane Electrode Assembly) interface.

### BACKGROUND OF THE INVENTION

The cost of fuel cells must be reduced dramatically to become commercially viable on a larger scale. The cost of the flow field plates, including the cost of forming the flow field onto the plate, represents a significant portion of the total cost within a fuel cell. Therefore, cost reduction of the flow field plate is imperative to enable fuel cells to become commercially viable on a larger scale. The cost reduction can be manifested in several ways including reducing the cost of the materials that are used to make the plate, reducing the manufacturing cost associated with making the plate, and/or improving the function/performance of the plate within a fuel cell so that the same fuel cell can produce electrical power more efficiently and/or produce more electrical power within the same fuel cell. Typically, developments in the flow field plate have attempted to optimize the trade-offs by reducing material cost and/or manufacturing cost while compromising performance-in-use.

A typical proton exchange membrane (PEM) fuel cell comprises several components. These components typically include a membrane, catalyst layers on the anode and cathode sides of the membrane known as the gas diffusion electrodes, and gas diffusion backings on each side. The membrane, electrode layers and gas diffusion backings are laminated together to create the membrane electrode assembly (MEA). Each MEA is sealed between two thermally and electrically conducting flow field plates. The seals are typically created by separate gasket components made of TEFLON® film, silicone or some elastomer material, such as VITON® fluoroelastomer available from DuPont Dow Elastomers. Each fuel cell is then “stacked” with other cells to achieve the required voltage and power output to form a fuel cell stack. Each stack is subjected to a compressive load to ensure good electrical contact between individual cells.

In operation, fuel is introduced on the anode side of the cell through flow field channels in the conductive flow field plates. The channels uniformly distribute fuel across the active area of the cell. The fuel then passes through the gas diffusion backing of the anode and travels to the anode catalyst layer. Air or oxygen is introduced on the cathode side of the cell, which travels through the gas diffusion backing of the cathode to the cathode catalyst layer. Both catalyst layers are porous structures that contain precious metal catalysts, carbon particles, ion-conducting NAFION® particles, and, in some cases, specially engineered hydrophobic and hydrophilic regions. At the anode side, the fuel is electrochemically oxidized to produce protons and electrons. The protons must travel from the anode side, across the ion-conducting electrolyte membrane, and finally to the cathode side in order to react with the oxygen at the cathode catalyst sites. The electrons produced at the anode side must be conducted through the electrically conducting porous gas diffusion backing to the conducting flow field plates. As soon as the flow field plate at the anode is connected with the flow field plate at the cathode via an external circuit, the electrons will flow from the anode through the circuit to the cathode. The oxygen at the cathode side will combine protons and electrons to form water as the by-product of the electrochemical reaction. The by-products must be continually removed via the flow field plate at the cathode side in order to sustain efficient operation of the cell. Water is the only by-product if hydrogen is used as the fuel while water and carbon dioxide are the by-products if methanol is used as the fuel.

Flow field separator plates are the outer components of each fuel cell and are in contact with the gas diffusion backing layers. The plates are called bipolar plates (BPPs) when used in a bipolar fuel cell stack. The BPPs provide many functions that place unusual demands on their materials of construction. BPPs have channels formed in their surfaces called “flow fields”. Flow fields are precision-engineered channels that are designed to optimize fluid flow across the active area of the fuel cell and thereby increase fuel cell performance. Dramatic gains in kW per m² power density achieved over the last ten years are due in large part to improved flow field design. BPPs also function to conduct electrons and heat from the active layer to an external load and must maintain this conductivity over a long operating life in a highly corrosive environment. Both electrical and thermal conductivity at the interface between the gas diffusion backing and the plate are critical for minimising fuel cell resistance. BPPs further provide physical separation of the oxidant and fuel in a bipolar fuel cell stack design and must maintain this separation throughout the lifetime of the stack to ensure a safe operation.

BPPs provide structural integrity within each fuel cell and within the fuel cell stack as a whole. Structural integrity is essential to a fuel cell stack in order to maintain adequate seals within each fuel cell for the lifetime of the fuel cell stack. Structural integrity is also important to provide uniform compressive stress across the active area of the fuel cell and thereby maintain optimum performance of the fuel cell stack. Because of their multi-purpose role in a fuel cell, BPPs have a number of requirements to meet. BPPs should have good electrical conductivity, good mechanical or structural properties and high chemical stability in the chemically reactive fuel cell environment. Because of their gas distribution role, BPPs should preferably be made of a gas impermeable material and be formed with complex gas delivery channels across its surface.

In some hydrogen-based PEM fuel cells, BPPs also act as “water transport plates”. The NAFION® membranes need water to function. These water transport plates are made permeable to water and relatively impermeable to hydrogen and air. Water produced at the cathode side of the cell gets transported through the plate to the anode side of the next cell in a bipolar stack design. The internally produced water is used on the anode side to humidify the membrane. This approach eliminates the need for a separate membrane humidification subsystem, thereby simplifying the balance-of-plant requirements.

Because of the performance requirements of conductive flow field plates and the aggressive conditions inside the fuel cell, the material options for constructing conductive flow field plates are limited. In general, graphite has been used for conductive flow field plates because of its high electrical conductivity and resistance to corrosion. Graphite however is typically produced in 6 mm thick slabs, adding both weight and bulk to the fuel cell and decreasing its power density when in use. Further, machining flow fields onto graphite plates is not cost effective.

Past attempts at solving the various requirements for fuel cell plates have also included the use of metal plates. The use of metal plates result in higher weight per cell, higher machining costs and possibly corrosion problems.

Carbon/graphite composites made with plastic polymers as binders have long been identified as a promising alternative to traditional materials in flow field plates. In U.S. Pat. No. 4,339,322 to Balks et al, there is disclosed a bipolar current collector plate for electrochemical cells comprising a moulded aggregate of graphite and a thermoplastic fluoropolymer particles reinforced with carbon fibres to increase strength and maintain high electrical conductivity.

In current fuel cell stacks designs, a sealing gasket such as an elastomeric gasket made of VITON®, must be used between the conductive flow field plates and the membrane in order to prevent any fuel leakage at the interface and to prevent compressive damage to the MEA caused by the clamping force applied on the fuel stack. The requirement to have a sealing gasket at each interface increases the cost of a fuel cell stack by complicating fuel cell design and also by increasing production cycle times to make fuel cell stacks.

U.S. Pat. No. 5,536,598 to Lafollette discloses bipolar plates comprising a composite of long carbon strands, a filler of carbon particles and a fluoroelastomer. A separate sealing material is necessary, however, to create a seal around the bipolar plates.

The disclosures of all patents/applications referenced herein are incorporated herein by reference.

There remains a need therefore to eliminate or at least reduce the need for separate sealing gaskets between the conductive flow field separator plates and the membranes used in fuel cells.

### SUMMARY OF THE INVENTION

The conductive flow field separator plates of the present invention are not only electro-conductive but their frame portions are elastomeric so that in the fuel cell stack the frame portions of the plates provide excellent sealing function at the plate/membrane interface and therefore eliminate the need for separate sealing gaskets. Optionally, the central portion of the plate may also be elastomeric, so that the high elasticity of the plates assists in preventing compressive damage to the MEA over the active area of the cell. Consequently, the fuel cell stack design becomes simpler and the cost of manufacturing the fuel cell stack becomes lower.

In accordance with one aspect of the present invention, there is provided an electrically conductive flow field separator plate for use in a proton exchange membrane fuel cell, comprising a frame portion, a central planar portion within the frame portion and a flow field formed in a surface of the central planar portion, wherein the frame portion is elastomeric so as to be capable of forming a seal with adjacent fuel cell components thereby eliminating the use of separate sealing elements. Optionally, the central portion is also elastomeric so as to be capable of providing elastomeric contact protection to the plate/MEA interface over the cell active area.

In accordance with a second aspect of the present invention, there is provided a method of making an electrically conductive flow field separator plate for use in a proton exchange membrane fuel cell, wherein the plate comprises a frame portion, a central planar portion within the frame portion and a flow field formed in a surface of the central planar portion, the method comprising:
(a) Mixing from about 10 wt % to about 50 wt % of elastomer, and from about 50 wt % to about 90 wt % of conductive filler, based on the total amount of elastomer and filler, and an effective amount of a cross-linking agent, to form a blend; and
(b) molding and simultaneously crosslinking the blend by applying sufficient heat and pressure to form the plate,
wherein the frame portion is elastomeric so as to be capable of forming a seal with adjacent fuel cell components thereby eliminating the use of separate sealing elements.

### BRIEF DESCRIPTION OF THE DRAWINGS

The preferred embodiments of the present invention will be described with reference to the accompanying drawings in which like numerals refer to the same parts in the several views and in which:

FIG. 1 is a schematic view of a preferred embodiment of the elastomeric conductive separator plate of the present invention.

FIG. 2 is a schematic cross-sectional view of a single PEM fuel cell of the prior art showing the sealing gaskets between the plates and the membrane.

FIG. 3 is a schematic cross-sectional view of a preferred embodiment of a single PEM fuel cell with the elastomeric separator plates of the present invention without the sealing gaskets.

### DETAILED DESCRIPTION OF THE PREFERRED EMBODIMENTS

The preferred embodiments of the present invention will now be described with reference to the accompanying figures.

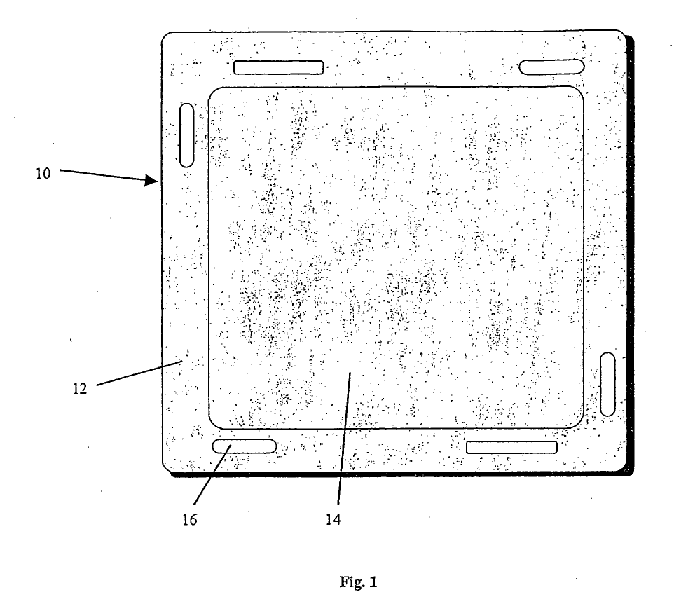

With reference to FIG. 1, there is shown a preferred conductive flow field separator plate 10 made in accordance with the preferred method of the present invention. The plate 10 is shown as being generally square in shape, but it will be understood that other shapes can be used such as rectangular and circular. The plate 10 includes a frame portion 12 about the plate's periphery and a central planar portion 14. The plate 10 also includes various manifold holes 16 for distribution of reactants to the fuel cell and for removal of reaction products from the cell. The central portion 14 will also include a flow field pattern (not shown) for distribution of the reactants and removal of reaction product. An example of a flow field pattern is provided in U.S. Pat. No. 5,858,569, which is incorporated herein by reference.

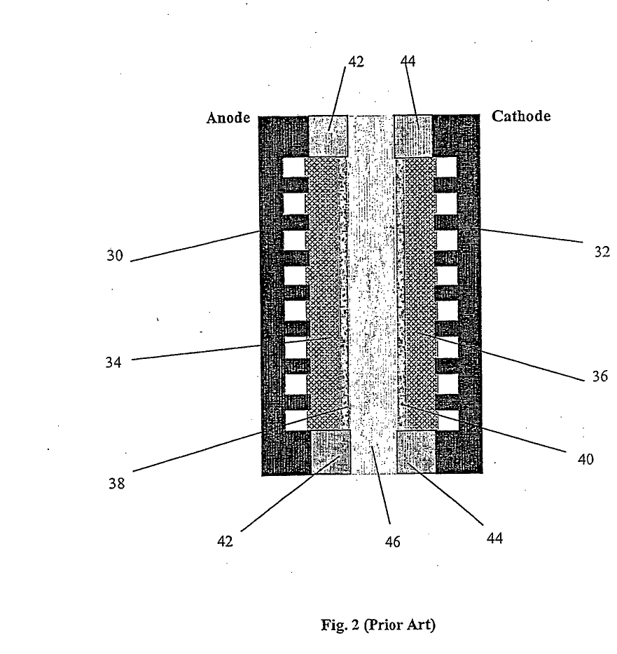

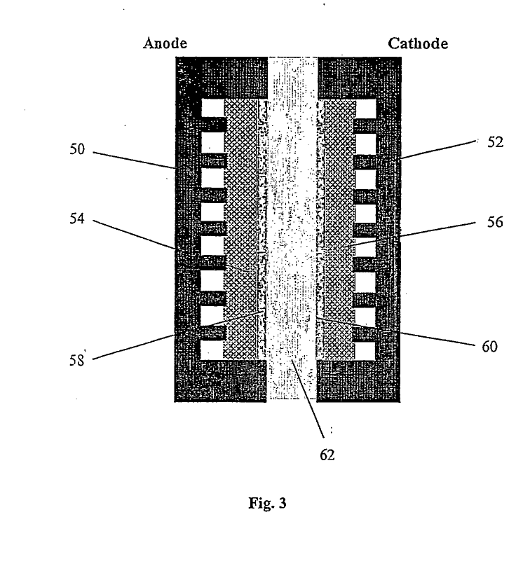

The frame portion 12 and central planar portion 14 are preferably of unitary construction and are made of a conductive elastomeric composition. The elastomeric composition is made highly conductive so that the plates 10 can be used as separator plates, also called current collectors, in fuel cells. The elastomeric plates 10 perform multiple functions: current collection, sealing and prevention of MEA damage. Plates 10 made in accordance with the present invention make fuel cell stack design simpler (see FIGS. 2 and 3) and fuel cell stack manufacturing cheaper. Plates 10 can be molded using a molding process such as compression molding, injection molding, extrusion or transfer molding. A flow field pattern/channel can be directly molded onto a surface or both surfaces of the central planar portion 14. Alternatively, the flow field channel may be machined onto the surfaces after the plate 10 has been molded. The elastomeric conductive plates 10 generally have a total cross sectional thickness of from about 0.5 mm to about 5 mm.

The plates 10 are made of a composition comprising elastomeric resins and electroconductive fillers. The preferred plate composition comprises from about 10 to about 50 wt %, more preferably from about 15 to about 30 wt %, of the elastomeric resins, and from about 50 to about 90 wt %, more preferably from about 70 to about 85 wt %, of the conductive fillers) based on the total amount of elastomer and filler.

Preferred elastomeric resins include cross-linkable thermoplastic elastomers, chlorinated elastomers, fluorinated elastomers, silicone elastomers, ethylene-polyethylene-diene-monomer elastomers, natural butyl rubber, and olefinic, polyamide-based, polyester-based and styrenic elastomers, and mixtures of these elastomers.

Cross-linkable thermoplastic elastomers that may be used in the present invention include KALTREZ® perfluoroelastomer, VITON® fluoroelastomer, HYPALON® chlorosulfonated polyethylene, NORDEL® IP hydrocarbon rubber, TYRIN® chlorinated polyethylene and ENGAGE® polyolefin elastomer from DuPont-Dow Elastomers.

A preferred chlorinated elastomer for use in this invention is a chlorosulfonated polyethylene available from DuPont Dow Elastomers as Hypalon®. Hypalon® chlorosulfonated polyethylene has demonstrated long life in harsh environments in applications that require high performance. It is capable of withstanding the heat and acidic environment found in a typical PEM fuel cell.

The preferred fluorinated elastomers are VITON® fluoroelastomer and KALTREZ® perfluoroelastomer available from DuPont-Dow Elastomers. They are well known for their excellent heat resistance and resistance to aggressive chemicals. They provide premium performance and long-term reliability in very harsh environments. Their resistance to heat aging and a broad range of fuels, solvents, and chemicals make them ideal for many demanding applications.

EPDM rubbers (ethylene-polyethylene-diene-monomer) are well known for their excellent weathering and aging resistance. They also have excellent water and steam resistance, maintain their flexibility at low temperatures, and feature excellent resistance to acids.

Silicone elastomers feature excellent resistance to ozone, sunlight and oxidation. They also maintain excellent flexibility at low temperatures and have good resistance to high heat.

The second component of the molding composition is conductive fillers. In accordance with the present invention, the conductive fillers impart electrical conductivity to the final molded elastomeric plate. The conductive fillers useful in the present invention include conductive graphite powders, graphite fibers, carbon black, carbon fibers, conductive ceramic fillers, metal fillers, metal-coated fillers and inherent conductive polymers (ICPs). As specific examples of graphite, there can be mentioned natural graphite, synthetic graphite and graphite fiber.

In a preferred form of the invention, the composite for the plate includes graphite fibre having a length of from about 50 to about 250 microns. Typically the average diameter of the fiber is in the range of 8 to 15 microns. The graphite fibre can be selected from any of the commercially available free flowing fibres. The graphite fiber can be pitch based or PAN-based. In the fiber production process, the fiber is graphitised at very high temperature for high graphite purity. The graphite powder may be selected from synthetic or natural graphite powders in the form of flakes or sphericals and is preferably in the form of flakes. The referred particle size of the graphite powders is from about 20 to 250 microns.

Other known additives may also be added to the molding composition. These additives include crosslinking agents such as peroxide or sulfur, acid acceptors such as magnesia, flame retardants such as halogenated hydrocarbons, plasticizers such as chlorinated paraffins, processing aids such as stearic acid. The total amount of these additives is usually in the range of from 0.1 to 20 parts by weight, based on 100 parts by weight of the elastomer used. A crosslinking agent is an important additive in the processing of the elastomeric composition. The crosslinking reaction must happen at the molding stage rather than the mixing or compounding stage of the composition. The amount of the crosslinking agent is usually in the range of 0.1 to 10 parts by weight, preferably 0.1 to 5 parts by weight, based on 100 parts by weight of the elastomer.

The molding composition for manufacturing the conductive plates 10 is prepared by mixing the elastomeric resin, conductive fillers and any additives (such as a crosslinking agent) via a compounding machine such as a twin screw extruder, a Buss Kneader™, a batch mixer (Brabender® or Banbury® mixer) or a roller-mill (with more than one roller). In a more preferred embodiment, the elastomeric resin and additives are mixed first and then the conductive fillers are added when the resin/additives have been homogeneously mixed and melted. A homogeneous uncured resin/filler/additives mixture is obtained from the mixing/compounding steps.

Preferably, the mixing/compounding temperature will be in the range of from about 20 to about 100° C., most preferably from about 40 to about 80° C. Mixing/compounding will take place for between about 0.1 to about 30 minutes, preferably from about 0.5 to about 20 minutes. The mixing temperature and duration are controlled so that preferably no cross-linking occurs during this mixing step.

The plates 10 are molded by transferring the homogeneous molding composition mixture to a compression mold, applying sufficient pressure on the mold for forming a plate form and heating the mold to the cross-linking reaction temperature of the cross-linking agent in the composition. After sufficient cross-linking, the formed plate is removed from the mold. A shaped conductive plate with or without flow fields is obtained from the molding (curing) step.

Preferably, the molding temperature will be in the range from about 120 to about 200° C., preferably from about 150 to about 180° C. Molding generally takes from about 0.1 to about 60 minutes, preferably from about 0.5 to about 20 minutes.

The resulting conductive flow field separator plate 10 has a bulk resistivity of less than 10 ohm-cm and can be in any desired shape, preferably square, rectangular or circular. These conductive plates 10 can be used as current collectors, also called separator, monopolar or bipolar plates, for application in fuel cells, batteries and other electrochemical devices. As well, the composition has good thermal conductivity and therefore can be used as thermal conductive rubber.

FIG. 2 shows a proton exchange membrane fuel cell of the prior art comprising anode separator plate 30, cathode separator plate 32, gas diffusion layers 34 and 36, catalyst layers 38 and 40, a proton exchange membrane 46 and sealing gaskets 42 and 44. The sealing gaskets 42 and 44 are necessary to provide an effective seal between the separator plates 30 and 32, and the membrane 46. In FIG. 3, a preferred fuel cell using the elastomeric separator plates from the present invention is illustrated in which the sealing gaskets are unnecessary. The anode separator plate 50 and the cathode separator plate 52 are made in accordance with the present invention and thus have an elastomeric frame portion. An effective seal is, therefore, created between the plates 50 and 52 and the proton exchange membrane 54. At the same time, in a preferred embodiment, the MEA comprising layers 54, 56, 58, 60 and 62, is also well protected by the elastomeric nature of the central portions of separator plates 50 and 52.

The following examples illustrate the various advantages of the preferred method of the present invention.

### EXAMPLES

### Example 1

A molding composition was prepared with the following components:
a. 80 wt % synthetic graphite powders;
b. 3% Magnesium oxide (stabilizer);
c. 1.2% Vulcup® peroxide (cross-linking agent); and
d. 15.8% Hypalon 6525® chlorinated polyethylene.

All ingredients were added onto a two-roller mill at 34° C., and the gab between the two rollers was regulated from 0.01″ to 0.08″ while the mill was rotating and the materials were being mixed. The mixing/compounding process was continued for 20 minutes and the compounded mixture was then collected.

The compounded mixture was then deposited into a mold cavity of 6″×6″×0.075″ and the mold heated to 176° C. When the temperature of the mold reached 176° C., pressure of 4000 PSI was applied on the mold for 20 minutes. The pressure was then released and the molded flat plate removed from the mold.

The bulk resistivity of the molded plate was then measured with a standard Four Point Probe method. The bulk resistivity of the plate was measured as 0.12 ohm-cm.

### Example 2

The sealing capability of the molded plates was tested by first machining standard serpentine channels on the surfaces of the molded plates (one anode and one cathode plate). The plates were then assembled into a fuel cell (100 cm active area) with a Nafion 117® membrane sandwiched between the two plates. No sealing gaskets were used. Compressed air was applied to the assembled cell for the leaking test. No air leakage was found in the range of normal operation pressure of below 8 PSI (gauge pressure).

Although the present invention has been shown and described with respect to its preferred embodiments and in the examples, it will be understood by those skilled in the art that other changes, modifications, additions and omissions may be made without departing from the substance and the scope of the present invention as defined by the attached claims.

1. An electrically conductive flow field separator plate for use in a proton exchange membrane fuel cell, comprising a frame portion, a central planar portion within the frame portion and a flow field formed in a surface of the central planar portion, wherein the frame portion is elastomeric so as to be capable of forming a seal with adjacent fuel cell components thereby eliminating the use of separate sealing elements.

2. The electrically conductive flow field separator plate of claim 1, wherein the central planar portion is elastomeric.

3. The electrically conductive flow field separator plate of claims 1 or 2, wherein the frame portion and the central planar portion are either of different or of unitary construction, and the frame portion and optionally the central planar portion comprising:
(a) from about 10 wt % to about 50 wt % of elastomer and from about 50 wt % to about 90 wt % of conductive filler, based on the total amount of elastomer and filler; and
(b) an effective amount of a cross-linking agent.

4. The electrically conductive flow field separator plate of claims 1 or 2, wherein the frame portion and the central planar portion are of unitary construction, comprising:
(a) from about 15 wt % to about 30 wt % of elastomer and from about 70 wt % to about 85 wt % of conductive filler, based on the total amount of elastomer and filler; and
(b) an effective amount of a cross-linking agent.

5. The electrically conductive flow field separator plate of claims 3 or 4 comprising from about 0.1 to about 10 parts by weight, based on 100 parts by weight of the elastomer, of the cross-linking agent.

6. The electrically conductive flow field separator plate of claims 3 or 4 comprising from about 0.1 to about 5 parts by weight, based on 100 parts by weight of the elastomer, of the cross-linking agent.

7. The electrically conductive flow field separator plate of any one of claims 3 to 6 further comprising from about 0.1 to 20 parts by weight, based on 100 parts by weight of the elastomer, of one or more additives selected from the group consisting of acid acceptors, flame retardants, plastisizers, processing aids, vulcanizing agents and mixtures thereof.

8. The electrically conductive flow field separator plate of any one of claims 3 to 7, wherein the elastomer is selected from the group consisting of crosslinkable thermoplastic elastomers, chlorinated elastomers, fluorinated elastomers, silicone elastomers, EPDM rubbers, natural butyl rubbers and mixtures thereof.

9. The electrically conductive flow field separator plate of any one of claims 3 to 7, wherein the conductive filler is selected from the group consisting of conductive graphite powders, graphite fibres, carbon black, carbon fibres, conductive ceramic fillers, metal fillers metal-coated fillers, inherent conductive polymers and mixtures thereof.

10. The electrically conductive flow field separator plate of any one of claims 3 to 7 wherein the elastomer is a chlorinated elastomer and the conductive filler is selected from graphite powders, graphite fibres and mixtures thereof.

11. The electrically conductive flow field separator plate of any one of claims 1-10 comprising flow fields on both surfaces of the central planar portion.

12. The electrically conductive flow field separator plate of any one of claims 1-11 having a bulk resistivity of less than 10 ohm-cm.

13. A method of making an electrically conductive flow field separator plate for use in a proton exchange membrane fuel cell, wherein the plate comprises a frame portion, a central planar portion within the frame portion and a flow field formed in a surface of the central planar portion, the method comprising:
(a) mixing from about 10 wt % to about 50 wt % of elastomer and from about 50 wt % to about 90 wt % of conductive filler, based on the total amount of elastomer and filler, and an effective amount of a cross-linking agent to form a blend; and
(b) molding the blend by applying sufficient heat and pressure to form the plate,
wherein the frame portion is elastomeric so as to be capable of forming a seal with adjacent fuel cell components thereby eliminating the use of separate sealing elements.

14. The method of claim 13, wherein in step (a), from about 15 wt % to about 30 wt % of elastomer; and from about 70 wt % to about 85 wt % of conductive filler, based on the total amount of elastomer and filler, are mixed to form the blend.

15. The method of claims 13 or 14 wherein about 0.1 to about 10 parts by weight, based on 100 parts by weight of the elastomer, of the cross-linking agent are mixed to form the blend.

16. The method of claims 13 or 14 wherein about 0.1 to about 5 parts by weight, based on 100 parts by weight of the elastomer, of the cross-linking agent are mixed to form the blend.

17. The method of any one of claims 13 to 16 wherein in step (a), from about 0.1 to 20 parts by weight, based on 100 parts by weight of the elastomer, of one or more additives selected from the group consisting of acid acceptors, flame retardants, plastisizers, processing aids, vulcanizing agents and mixtures thereof are mixed.

18. The method of any one of claims 13 to 17, wherein the elastomer is selected from the group consisting of crosslinkable thermoplastic elastomers, chlorinated elastomers, fluorinated elastomers, silicone elastomers, EPDM lubbers, natural butyl rubbers and mixtures thereof.

19. The method of any one of claims 13 to 17 wherein the conductive filler is selected from the group consisting of conductive graphite powders, graphite fibres, carbon black, carbon fibres, conductive ceramic fillers, metal fillers metal-coated fillers, inherent conductive polymers and mixtures thereof.

20. The method of any one of claims 13 to 17 wherein the elastomer is a chlorinated elastomer and the conductive filler is selected from graphite powders, graphite fibres and mixtures thereof.

21. The method of any one of claims 13-20 further comprising the step of forming a flow field on a surface the central planar portion.

22. The method of any one of claims 13-21 wherein the plate has a bulk resistivity of less than 10 ohm-cm.

23. The method of any one of claims 13-22, wherein step (a) is carried out at a mixing temperature of from about 20 to about 100° C. for a mixing time of from about 0.1 to about 60 minutes.

24. The method of any one of claims 13-22, wherein step (a) is carried out at a mixing temperature of from about 40 to about 80° C. for a mixing time of from about 0.5 to about 20 minutes.

25. The method of any one of claims 13-24, wherein step (b) is carried out at a molding temperature of from about 120 to about 200° C. for a molding time of from about 0.1 to about 60 minutes.

26. The method of any one of claims 13-24, wherein step (b) is carried out at a molding temperature of from about 150 to about 180° C. for a molding time of from about 5 to about 20 minutes.
